(19) United States
(12) Patent Application Publication
(10) Pub. No.: US 2006/0051589 A1
(43) Pub. Date: Mar. 9, 2006

(54) Fluorinated overcoat to improve chemical and wear resistance of finished surfaces

(76) Inventor: John H. Rohlfing, Kokomo, IN (US)

Correspondence Address: DELPHI TECHNOLOGIES, INC., M/C 480-410-202, PO BOX 5052, TROY, MI, 48007, US

(21) Appl. No.: 10/935,022

(22) Filed: Sep. 7, 2004

(51) Int. Cl. B32B 27/00; B32B 27/30; B32B 27/40; B60R 13/00; B05D 3/02

(52) U.S. Cl. 428/423.1; 428/421; 428/31; 428/422; 428/336; 428/522; 427/372.2

(57) ABSTRACT

A protective coating for automotive interior components includes an aesthetic finish and an outer fluoropolymer protective layer. The fluoropolymer layer provides a barrier to protect the aesthetic qualities of the aesthetic finish from degradation, for example, from exposure to chemicals and contact wear. The aesthetic finish may include an aesthetic layer, for example, a paint layer. The component includes a substrate, for example a plastic, metal, wood, or other structural material, having an outer surface that is exposed to the automotive interior. The fluoropolymer layer is ultra-thin and is substantially transparent so that the visual appearance of the aesthetic layer is not noticeably altered. A method of providing a protective barrier for an automotive interior component finish includes providing a solution of fluoropolymer and solvent and applying the solution to the component finish.

### TECHNICAL FIELD

The present invention relates generally to automobile interior materials, and more specifically to protective coatings for automotive interior surfaces.

### BACKGROUND OF THE INVENTION

Exposed component surfaces in automotive interiors, for example, painted or unpainted trim panels, control actuators, instrument panels, dashboards, door liners, and the like, are often exposed to chemicals, contact wear, and other environmentals that may damage the surface finish. For example, harsh chemical and wear exposure can degrade the aesthetic quality of the finish, including the visual and tactile qualities. Some finish coatings, such as soft feel, metallic, and acrylic-based paints, are more susceptible to certain types of degradation than other finishes, especially from harsh chemicals such as ethyl alcohol and DEET. These and other harsh chemicals are used in common products such as hand sanitizers and insect repellants that are applied to the skin and subsequently transferred by hand contact to automotive interior surfaces, such as control actuators and trim panels of the type used on audio, multimedia, and HVAC control heads, resulting in degradation of some component surface finishes.

In recent years, customer preference for automotive interior finishes and shifts in desired manufacturing materials have led to an increase in the use of paint and other types of coatings that are less chemical and wear resistant than prior materials used for such finishes. For example, while solvent-based paints were once used to finish most interior surfaces, water-based paints such as acrylics are now primarily being used. Additionally, automotive manufacturer requirements for chemical and wear resistance have been heightened. As a result, there has been an unmet need to provide finishes with increased hardness and imperviousness while retaining the use of desired paint and other coating materials and desired aesthetic qualities.

Attempts have been made to provide a protective barrier layer overlying the paint or other aesthetic finish. For example, when the aesthetic finish consists of a resin-based paint, attempts to provide a barrier layer have included applying a overcoat layer of unpigmented paint that uses the same resin base as the underlying aesthetic layer. Unfortunately, adding the overcoat layer adds additional material, cost, and process complexity. Additionally, the overcoat layer is generally about 1 mil thick, which is sufficiently thick to noticeably degrade the visual appearance of the underlying aesthetic layer. While the paint and coating industry also offers other options for barrier layers other than resin-based paints and also more expensive single layer paints, to date none of these options have offered a suitable combination of chemical and wear resistance, cost, complexity of process, and protection of the underlying aesthetic layer while not substantially altering the aesthetic qualities.

What is therefore needed is an improved process and finish coating that provides the desired advantages for automotive interior finishes.

### SUMMARY OF THE INVENTION

A protective coating for automotive interior components according to the present invention includes an aesthetic paint layer and an outer fluoropolymer protective layer. The fluoropolymer layer provides a barrier to protect the aesthetic qualities of the paint layer from degradation, for example, from exposure to chemicals and contact wear. Exemplary components includes a substrate, for example a plastic, metal, wood, or other structural material, having an outer surface that is exposed to the automotive interior. The substrate may form, for example, a trim panel or control actuator such as those normal located in the interior of an automobile, for example, the instrument panel, including audio, multi-media, and HVAC control heads.

The outer surface of the substrate receives the aesthetic and overlying fluoropolymer layers. Advantageously, the fluoropolymer layer is substantially transparent so that the visual appearance of the aesthetic layer is not noticeably altered. The fluoropolymer layer may also be applied directly to the substrate without an intervening aesthetic layer.

A method of providing a protective barrier for an automotive interior component finish according to the present invention includes providing a solution of fluoropolymer and solvent and applying the solution to the component finish. Advantageously, the fluoropolymer layer thickness is self-limiting. The fluoropolymer molecules bind to the substrate or aesthetic layer but resist binding to other fluoropolymer molecules, thus limiting the thickness, in theory, to one molecule in some embodiments.

In accordance with one aspect of the present invention, an interior component for an automobile includes a substrate having an exposed finish surface and a fluoropolymer layer applied to the finish surface.

In accordance with another aspect of the present invention, a protective coating for an automotive interior component includes an aesthetic layer applied to an exposed surface of the automotive interior component, and a fluoropolymer layer applied to the aesthetic layer.

In accordance with a further aspect of the present invention, a method of providing a protective barrier for an automobile interior component finish includes providing a solution of fluoropolymer and solvent, applying the solution to the component finish, and allowing the solvent to evaporate, leaving a layer of the fluoropolymer bonded to the component finish.

In accordance with yet another aspect of the present invention, an interior component for an automobile includes a substrate having an exposed surface, and a fluoropolymer layer applied to the exposed surface.

These and other features of the present invention will become more apparent from the following description of the illustrative embodiments.

### BRIEF DESCRIPTION OF THE DRAWINGS

The present invention will now be described, by way of example, with reference to the accompanying drawings, in which:

FIG. 1 is a cross-sectional view of an automobile interior component having aesthetic and protective layers according to the present invention; and

FIG. 2 is a perspective view of a portion of an automobile interior, including the interior component of FIG. 1.

### DETAILED DESCRIPTION

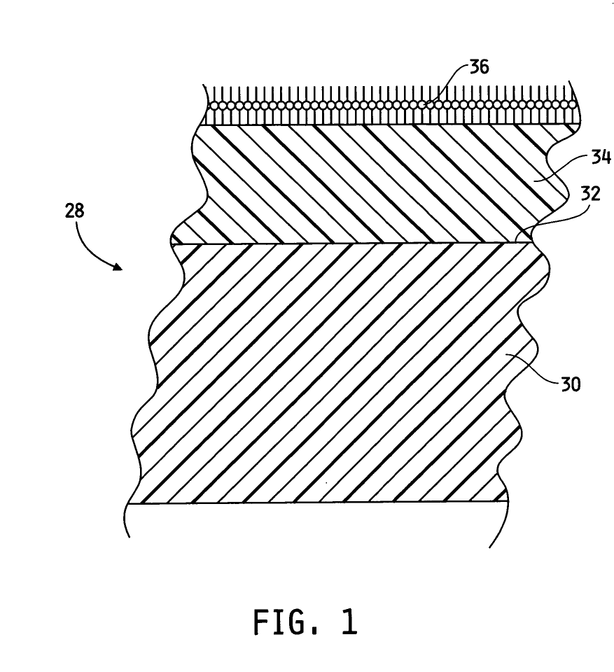

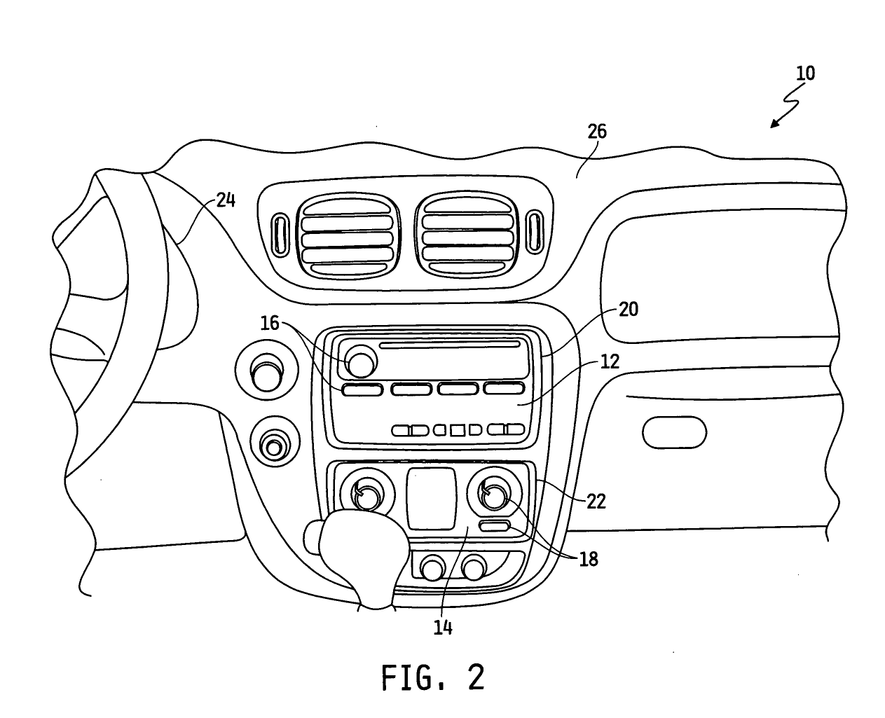

Referring now to FIG. 2, automotive interior components 10, include painted or unpainted trim panels 12, 14 and control actuators 16, 18 of audio and HVAC control heads 20, 22, instrument panels 24, dashboard components 26, door liners (not shown), steering wheel, shift lever, and any other automotive interior component having an exposed surface. Referring now to FIG. 1, exemplary automotive interior component 28 is formed from substrate 30, for example a plastic, metal, wood, or other structural material, having outer surface 32 that is exposed to the automotive interior. Component 28 generally includes an aesthetic finish providing desired visual and tactile qualities. The aesthetic finish may be formed by outer surface 32 or by aesthetic layer 34 that is adhered to outer surface 32. Aesthetic layer 32 is generally formed by a paint or other coating material, for example, soft feel urethane-based paint or metallic and non-metallic acrylic-based paints.

To protect the aesthetic qualities of outer surface 32 or aesthetic layer 34, protective layer 36 is applied as a final overlay to component 28. Protective layer 36 is formed by applying a solution of fluoropolymer and solvent to outer surface 32 or aesthetic layer 34. The solvent is allowed to evaporate, leaving a hardened wear and chemical resistant layer adhered to aesthetic layer 34 or outer surface 32. Protective layer 36 also resists adhesion of tape and other adhesives to its exposed outer surface.

Components 10 are generally formed from inexpensive, suitably durable, and easily formed materials, including such materials as metal, alloy, acrylonitrile-butadiene-styrene (ABS), acrylic, polycarbonate (PC), polyphenylene oxide, nylon, polyvinyl-chloride (PVC), thermoplastic olefin (TPO), urethane, and wood. A desired aesthetic finish for components 10, such as exemplary component 28, may be achieved by using additives in substrate 30 or by polishing, anodizing, or otherwise finishing surface 32 of substrate 30. A desired finish may further be achieved by applying aesthetic layer 34 to surface 32.

Aesthetic layer 34 is generally a paint or other coating solution or powder that is applied to surface 32 of component 28 and is then allowed to dry or is otherwise hardened. Common paints that provide the desired cost, low complexity of process, and aesthetic qualities include urethane-based soft feel paints and acrylic-based metallic and non-metallic paints.

Components 10, especially those often manipulated or otherwise contacted by automobile operators and occupants, are subjected to chemicals, contact wear, and other environmentals that tend to degrade aesthetic layer 34 and/or outer surface 32, particularly in cases where no aesthetic layer 34 exists. For example, control actuators 16, 18, such as pushbuttons and rotary switches, and trim panels 12, 14 of audio and HVAC control heads 20, 22 are regularly contacted by an occupant of the vehicle.

Such contact exposes aesthetic layer 34 to regular wear, to body oils, and to chemicals used in personal products. For example, hand sanitizers often include ethyl alcohol and some insect repellents include DEET, both of which tend to be corrosive to many of the above-mentioned commonly used finishes that form aesthetic layer 34. Over time, such exposure can degrade the aesthetic qualities of aesthetic layer 34. For example, aesthetic layer 34 may be worn through in places or the tactile and/or visual quality changed by contact wear and by chemicals that act as solvents or otherwise damage the paint or other material forming aesthetic layer 34.

Protective layer 36 provides a barrier that is more resistant to the chemicals and wear that tend to degrade aesthetic layer 34. Protective layer 36 is formed primarily by a fluoropolymer and is more resistant to wear and is more impervious to the chemicals of concern than are typical finishes forming aesthetic layer 34. In order to maintain the visual and tactile qualities of aesthetic layer 34, protective layer 36 is also relatively transparent and thin. For example, conventional resin-based overcoat layers are about 1 mil thick, which reduced the visual quality of aesthetic layer 34 when viewed through the overcoat layer. In contrast, the thickness of protective layer 36 is about 1 micron, or less, for example, about 100 nanometers, and may potentially be as thin as one fluoropolymer molecule. The ultra-thin monomolecular or nearly monomolecular layer is achieved because the fluoropolymer used tends to be self-limiting in thickness. The active end of the fluoropolymer binds to the applied surface of component 28, but not to itself, thus forming a monomolecular layer as is schematically illustrated in FIG. 1 and allowing the excess solution to freely flow off of component 28. However, the molecules of protective layer 36 may be oriented in multiple directions, intertwined, and the like.

Illustrative protective layers 36 are polyfluoro or perfluoro aklylene polymers, including polyfluoro or perfluoro polyethylene, polyproylene, polybutylene, polybutadiene, and the like. In particular, illustrative protective layers 36 include poly (tetrafluoroethylene) (PTFE), poly (hexafluoropropene), poly (octafluorobutene), and the like. One such exemplary protective layer 36 is formed from oxidized, polymerized 1,1,2,3,3,3-hexafluoro Propene which is provided in a solution of up to 2.0%, for example, in a fluoroalkane solvent or water. Such a solution is available from Nye Lubricants, of Fairhaven, Mass., and is known as NyeBar Type-Q (registered trademark of Nye Lubricants).

Two prior known uses of the exemplary solution are specific to the lubrication industry. In one application, the solution is used to form a dam around a mechanical structure requiring lubrication, for example bearings. The change in wettability of the surface resulting from the added dam prevents migration of the lubricant to other areas of the structure. In the other application, the solution is applied to electrical contacts of circuit boards to prevent silicone and other oils used on adjacent electrical or other components from migrating onto the electrical contacts. The wettability of the contacts is altered, thereby preventing lubrication migration, yet the layer is thin enough to allow electrical conduction. While the exemplary solution is known in the lubrication industry to prevent lubricant migration, it is not believed to have been used heretofore as a protective layer to provide chemical and wear resistance and to prevent tape adhesion for the above-disclosed paint and coating applications in exposed surfaces of automotive interiors.

Because the thickness of exemplary solution is self-limiting, it may be applied to component 28 by using any of a number of conventional techniques, for example, spraying, dipping, wiping, and brushing. While the solvent may be evaporated by exposing component 28 to ambient air, after applying the exemplary solution, protective layer 36 may also be heat treated if tolerated by substrate 30 and aesthetic layer 34 for increased durability. For example, Nye Lubricants recommends baking the applied layer for 15 minutes at 100 degrees C. for increased durability of layer 36.

Tests completed on two exemplary components 28 demonstrated increased wear resistence, chemical resistance, and resistance to tape adhesion over components not having protective layer 36. Specifically, components 28 included substrate 30 formed from polycarbonate and two different aesthetic layers 34, one formed from satin nickel metallic paint 418 and the other formed from mica ebony soft feel paint, both available from Red Spot of Evansville, Ind.

Tests included Tabor abrasion, (reported in the table below in revolutions to failure), RCA abrasion (reported in cycles to failure), tape adhesion, and resistance to various chemicals based on commonly used products, including WINDEX (registered trademark of S.C. Johnson & Son, Inc.), SPIC & SPAN (registered trademark of The Spic and Span Company), DEEP WOODS OFF! (registered trademark of S.C. Johnson & Son, Inc.), and PURELL (registered trademark of GOJO Industries, Inc.). While unprotected aesthetic layers 34 generally failed the various tests, aesthetic layers 34 overcoated with protective layer 36 formed from fluoropolymer passed all tests.

| | soft feel | soft feel | metallic | metallic |
|---|---|---|---|---|
| | without | with | without | with |
| Test | overcoat | overcoat | overcoat | overcoat |
| Tabor | 225 | >200 | 200-245 | 300 |
| RCA | 12-15 | 25-85 | 35-80 | 50-115 |
| Tape | pass | pass | fail | pass |
| Adhesion | | | | |
| Chemical | fail: OFF! | pass | fail: WINDEX, | pass |
| Resistance | | | SPIC & SPAN, | |
| | | | OFF!, PURELL | |

While the invention has been illustrated and described in detail in the foregoing drawings and description, the same is to be considered as illustrative and not restrictive in character, it being understood that only the illustrative embodiments have been shown and described and that all changes and modifications that come within the spirit of the invention are desired to be protected.

1. An interior component for an automobile, comprising:
a substrate having an exposed finish surface; and
a fluoropolymer layer applied to said finish surface.

2. The interior component of claim 1, wherein said finish surface includes an aesthetic layer applied to said substrate.

3. The interior component of claim 1, wherein said substrate comprises at least one of a trim panel and a control actuator.

4. The interior component of claim 1, wherein said fluoropolymer layer includes polymerized 1,1,2,3,3,3-hexafluoro Propene.

5. The interior component of claim 1, wherein said fluoropolymer layer includes a polyfluoro or perfluoro polyalkylene polymer.

6. The interior component of claim 1, wherein said fluoropolymer layer is about 1 micron thick or less.

7. The interior component of claim 1, wherein said fluoropolymer layer is between about 1 micron and about one fluoropolymer molecule thick.

8. The interior component of claim 1, wherein said fluoropolymer layer is substantially impervious to at least one of body oils, skin products, DEET, and ethyl alcohol.

9. The interior component of claim 1, wherein said fluoropolymer layer is substantially transparent.

10. The interior component of claim 2, wherein said aesthetic layer includes at least one of metallic paint, urethane paint, and acrylic paint.

11. The interior component of claim 1, wherein said substrate includes at least one of metal, alloy, acrylonitrile-butadiene-styrene, acrylic, polycarbonate, polyphenylene oxide, nylon, poly-vinyl-chloride, thermoplastic olefin, urethane, and wood.

12. A protective coating for an automotive interior component, comprising:
an aesthetic layer applied to an exposed surface of the automotive interior component; and
a fluoropolymer layer applied to said aesthetic layer.

13. The protective coating of claim 12, wherein said aesthetic layer includes at least one of metallic paint, urethane paint, and acrylic paint.

14. The protective coating of claim 12, wherein said aesthetic layer is about 1 mil thick.

15. The protective coating of claim 12, wherein said fluoropolymer layer is about 1 micron thick or less.

16. The protective coating of claim 12, wherein said fluoropolymer layer is between about 1 micron thick and about one fluoropolymer molecule thick.

17. The protective coating of claim 12, wherein said fluoropolymer layer includes polymerized, 1,1,2,3,3,3-hexafluoro, oxidized and Propene.

18. The protective coating of claim 12, wherein said fluoropolymer layer includes a polyfluoro or perfluoro polyalkylene polymer.

19. The protective coating of claim 12, wherein said aesthetic layer and said fluoropolymer layer are applied to an outer surface of at least one of a trim panel and a control actuator.

20. A method of providing a protective barrier for an automobile interior component finish, comprising:
providing a solution of fluoropolymer and solvent;
applying the solution to the component finish; and
allowing the solvent to evaporate leaving a layer of the fluoropolymer bonded to the component finish.

21. The method of claim 20, wherein said fluoropolymer includes polymerized 1,1,2,3,3,3-hexafluoro Propene.

22. The method of claim 20, wherein said solvent includes at least of fluoroalkane and water.

23. The method of claim 20, wherein said solution is applied to the component finish by at least one of spraying, dipping, wiping, and brushing.

24. The method of claim 20, comprising the further step of thermally treating the fluoropolymer after application.

25. The method of claim 20, wherein said component finish includes an uncoated exposed surface of the component.

26. The method of claim 20, wherein said component includes at least one of a trim panel and a control actuator.
